(19) United States
(12) Patent Application Publication
(10) Pub. No.: US 2012/0173482 A1
(43) Pub. Date: Jul. 5, 2012

(54) METHOD FOR ENRICHMENT AN ELECTRONIC PHONE BOOK PROVOKED BY A CHANGE IN THE ASSOCIATED TERMINAL, AND ASSOCIATED DEVICE

(75) Inventors: Alain Brun, Aubagne (FR); David Halle, Toulon (FR); Christophe Foesser, La Ciotat (FR); Lionel Mallet, Marseille (FR); Frédéric Faure, Cassis (FR)

(73) Assignee: GEMALTO SA, Meudon (FR)

(21) Appl. No.: 12/809,027

(22) PCT Filed: Dec. 17, 2008
(86) PCT No.: PCT/EP2008/067803

§ 371 Date: Aug. 4, 2010

(30) Foreign Application Priority Data
Dec. 21, 2007 (EP) 07301733.7

(51) Int. Cl. G06F 7/00

(52) U.S. Cl. 707/609; 707/E17.044

(57) ABSTRACT

The invention relates to a method for the enrichment of an electronic directory stored in a first electronic communication device, based on the changes in a second electronic communication device and by the application of decisional rules. The changes can also be related to a change in the hardware or software functionalities or to a modification of data contained in said second device.

The invention relates to a method for enrichment of an electronic directory triggered by a change in the associated telephone, and the related device.

The invention more particularly relates to means for triggering the enrichment of an electronic directory as a function of a change in the software or hardware functionalities of the associated telephone, in compliance with decisional rules.

The massive popularisation of mobile telephones has been accompanied by the multiplication of electronic directories related thereto. In addition, a large diversification of communication means such as electronic mail messages or instant message services simultaneously occurred.

The problem we meet consists in keeping the electronic directories as update as possible.

Most existing solutions are based on a user's deliberate action. As a matter of fact, in these solutions, the user decides to adapt the contents of his or her directory to his or her needs.

Other existing solutions are based on the user's behaviour and offer the user to update his or her directory as a function of his or her behaviour. For example, receiving a call from a person not saved in the directory may trigger a proposal to the user of saving said number into the electronic directory. Such solutions are limited to completing a field in the directory already used by the user. If the user has never used his or her phone to send electronic messages, such solutions will not propose to fill the field “electronic address”.

The common problem to all these existing solutions is that the enrichment of the directory is always related to the user. Thus, the enrichment is always proposed as a reaction. Thus, it is a lack which triggers the enrichment. There is no solution making it possible to enrich an electronic directory as a function of the means placed at the user's disposal without the latter having necessarily used or being aware of the above-mentioned means.

In this description, the term “enrichment” will be used to refer to an action consisting in adding at least one piece of information in at least one location of the electronic directory. This step is closely related to the present invention and uses known mechanisms which are not disclosed in this document.

In this description, the word “modification” will be applied to an electronic communication device. This term relates to any detectable change in the device at issue of one or several value(s) among a finite set of predefined values “to be watched”.

Thus, this term relates to, for example, a change in the peripheral units connected to the device or a change in registers stored in the memory.

A value to be “watched” is a value or a parameter which has been defined, through decisional rules according to the invention, as having to be particularly watched and any change of which should be detected and transmitted.

In a first embodiment of the invention, the values to be watched can be limited to the parameters of a telephone connected to the identity and to the type of network which said telephone is connected to. In another embodiment, such values can, in addition, include a list of peripheral units connected to the telephone, of registers containing digital communication keys as well as various communication media available through the phone (Bluetooth, wifi, infrared, . . .). In a third embodiment, any value related to the phone can be considered as “to be watched”: registers, content of each memory of the phone, hardware parameters, etc.

In the present description, the word “decisional rules” will be used to refer to a set of instructions which make it possible to define the action to be taken, as a function of one or several parameters input.

In this invention, such rules make it possible to point out the values to be watched and the reactions to have as a function of the modifications in the so designated values.

Then, such rules make it possible to build a strategy of enrichment, either alone or in combination, as a function of the modifications in the values to be watched and as a function of the electronic directory. Such strategy will, for example, define whether the electronic directory should be enriched. If so, said strategy defines the range, the time and the data of the enrichment. Such strategy stipulates whether the user's approval is requested or not prior to carrying out said enrichment.

In addition, such rules have the property of being modifiable. Such modifications can be brought for example as a function of the functional evolution of the telephone, the directory, further to an external event such as for example the reception of a message or an action by the user.

The present invention aims at remedying the drawbacks of the solutions of the prior art in order to provide the optimisation of the data in the electronic directory of a telephone as a function of the evolutions of said telephone.

Therefore, the present invention is a method for the enrichment of an electronic directory stored in a first electronic communication device, such electronic communication device being connected to a second electronic communication device able to set up a telephone call with a first device being able to enrich said electronic directory and implement said method of enrichment, such method further including the steps of:
detection during which a modification of a parameter to be watched of said second electronic communication device is automatically detected by said first electronic device;
diagnostics during which, after the reception of the triggering event, the diagnostics of the second electronic communication device is executed;
processing during which predefined decisional rules are applied to the diagnostics and an enrichment of the electronic directory is planned.

According to an embodiment, the step of diagnostics can include the analysis of the information relative, among others, to the hardware which constitutes the second electronic communication device or an analysis of the information relative among others to the software elements aboard the second electronic communication device or even the analysis of the whole or a part of the data contained in the memory of said second electronic communication device.

According to one embodiment, the step of detection includes a detection of a modification which can be related either to the hardware constituting said second electronic communication device or the software elements aboard said second electronic communication device, or the data contained in said second electronic communication device.

The present invention is also an electronic communication device capable of enriching said electronic directory, which includes:
means for detecting modifications of parameter to be watched of a second electronic communication device;
means for identifying the modifications in said second electronic communication device which occurred through the diagnostics of said second electronic communication device;
means for storing decisional rules;
means for analysing decisional rules with regard to said diagnostics;
means for planning the enrichment of the electronic diary.

Such electronic communication device can store the information resulting from the latest diagnostics carried out in a non-volatile memory.

The electronic communication device can store the electronic directory, in a non-volatile memory.

Other characteristics and advantages of the invention will clearly appear upon reading the description thereof which is given as an indication, and not a limitation, and while referring to the appended drawings, wherein:

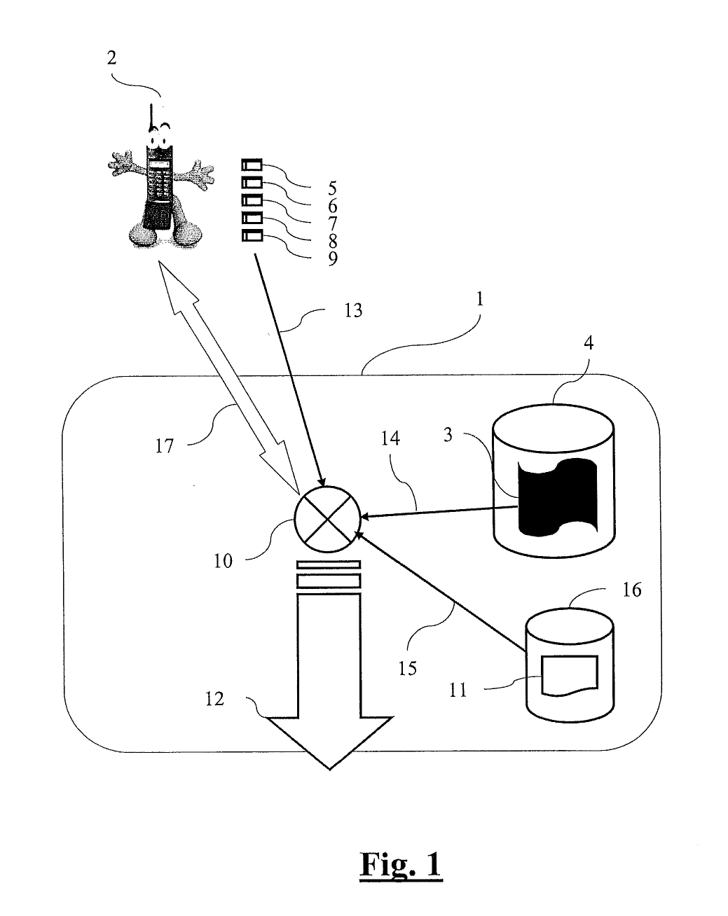

FIG. 1 shows a system for the enrichment of an electronic directory according to the invention.

In FIG. 1, the first electronic device is a chip card 1 and the second electronic communication device is a mobile telephone 2.

FIG. 1 shows a particular embodiment of the invention wherein the method is implemented by the chip card 1. The method according to the invention can also be implemented in the telephone 2 or even in a third party device as will be explained further down.

The electronic directory 3 liable to be enriched is stored in a memory 4 of the card 1.

A set of parameters 5, 6, 7, 8, 9 relative to the telephoned are identified.

Among one of such parameters, we can mention for example:
the list 5 of the accessories connected to the telephone 2. Such a parameter is particularly interesting since it makes it possible to show the addition, for example, of hands-free kits or the connection of the telephone to an electronic agenda or a computer;
a zone 6 in the memory including the identifier of the network which the telephone 2 is currently connected to;
a zone 7 in the memory containing the type of network which the telephone 2 is currently connected to. This type can, for example, make it possible to recognise a second generation network, a third generation network, etc. . . .;
the list 8 of the software applications installed in the telephone 2;
a reference 9 to a datum saved in the memory of the telephone 2.

When one of these parameters 5, 6, 7, 8, 9 is modified, the chip card 1 detects this action. This detection can be carried out in several ways. One solution illustrated in FIG. 1 consists in trusting the detection of the modifications to software means contained in the telephone 2 which regularly checks the values of the parameters 5, 6, 7, 8, 9 and send a warning 13 to a programme 10, hosted in the chip card 1, when such modification occurs. Such warning can be provided, for example, through the transmission of a message, an electric signal or an interruption.

Another solution consists in making such checking from the chip card 1. In this embodiment, the card 1 keeps the previously read value of the parameters 5, 6, 7, 8, 9 in a local memory, and regularly interrogates the telephone so as to compare the current values of the parameters 5, 6, 7, 8, 9 with the saved values. In this solution, the method according to the invention uses no warning 13.

After the detection of the modification in the whole or a part of the parameters 5, 6, 7, 8, 9, the method according to the invention will automatically request a diagnostics 17 of the telephone 2.

Such step of diagnostics may be carried out under many various forms according to the embodiment. In one of such modes, the diagnostics can be limited to the reading of the values of the whole or a part of the parameters 5, 6, 7, 8, 9. In another embodiment, the diagnostics concerns elements which are not necessarily directly related to the parameters.

For example, the list 5 has been modified. As soon as the warning 13 is received by the programme 10, the diagnostics phase interrogates the telephone on the nature of the modifications which occurred with regard to the accessories connected. In this example, the diagnosis goes beyond the simple reading of the value of the parameter 5.

In the case of a modification in the zone 7 of the memory containing the type of network which the telephone 2 is currently connected to, the diagnostics 17 may consist only in reading of the new value of the zone 7 in the memory.

In a particular embodiment of the invention, the warning 13 may contain the value of the parameter or parameters 5, 6, 7, 8, 9 which has/have been modified. In this case, the warning may be used as diagnostics.

Once it knows the diagnostics of the telephone 2 according to the method of the invention, the programme goes to a processing step which resorts to decisional rules 11 saved in the card 1 memory 16.

In a particular embodiment of the invention, such rules can be hosted in another electronic device than the card 1.

Such decisional rules will enable an automatic decision-making as a function of the information obtained during the step of diagnostics. It can be considered that such step of processing requires additional information which can be obtained through additional diagnostics 17 or a consultation 14 of the directory 3.

The access 14 to the electronic directory 3 may require the setting up of a connection to a third party device, if the latter contains the directory 3, and the downloading 14 thereof.

The conclusion of the processing step can be scheduling of the enrichment 12 of the electronic directory 3 or not scheduling such enrichment 12.

For example, the diagnostics 17 triggered by a modification in the list 5 shows that the hands-free kit was disconnected from the telephone. In this case, the application of the decisional rules can lead to a decision not to enrich the electronic directory 3.

Scheduling the enrichment 12 consists in defining the elements of the electronic directory to be updated and in planning such updating in time. The method of updating is not in itself disclosed in this invention, and in our example, will be based on methods well known to the persons skilled in the art.

In one embodiment of the method according to the invention, the application of the rules 11 further to the detection 13 of the installation of an electronic message application in a telephone 2 automatically leads to the planning of the enrichment of the electronic directory 3 in the form of a collection of information making it possible to obtain the electronic addresses corresponding to the names existing in the directory upon the next connection to the Internet.

In one embodiment of the method according to the invention, planning the enrichment of the directory may be submitted to an action by the user. Such an action can be the acknowledgement or a more complex action such as, for example, the filling of a particular field or the setting up of a particular connection. The enrichment 12 may, for example, require the user to supply an identifier and a password giving access to a remote database.

All the decision rules 11 according to the invention can easily be updated. Such updating can be executed by the user himself or herself or through the messages received by the telephone. Such messages can, for example, be sent by a computer through the connection which connects it to the telephone or through so-called “Short Messages Services” messages received by the telephone through the wireless telephone network or any other communication means, for example, of the radiofrequency type.

The updating of the decisional rules 11 makes it possible to provide an optimum operation of the invention in contexts which were not foreseen beforehand. Such a situation may occur, for example, with new types of network or new available functionalities. For example, one or several new rule(s) can be sent by the user's telephone operator if such operator currently decides to provide an instant messaging service. Then, according to the invention, if the user downloads into the telephone an instant messaging programme, the list 8 of the software applications installed in the telephone 2 will be modified and according to the method of the invention, further to the detection 13 of such modification, a diagnostics of the telephone will be triggered and will reveal this new application.

The application of the new decisional rules will, for example, enable the programme 10:
to provide the user with the possibility of filling the connection parameters if possible, then
to schedule the enrichment of the electronic directory to try and find the identifiers of such instant messaging service relative to the persons saved in the directory.

According to the embodiments, the devices 1 and 2 can be connected in various ways. For example, the card can be physically in contact with the telephone, which is the general case of the mobile telephones with a SIM (Subscriber Identity Module) card aboard.

In another embodiment, both devices can be connected, for example, through a link of the radiofrequency type.

The method according to the invention can advantageously be implemented in a system including only one electronic device which will include both the card functionalities and the telephone functionalities.

In this case, the electronic directory, the decisional rules and the method according to the invention are all physically gathered on a same device which is also used as a telephone. In this case, the above-mentioned devices are distinguished only by their functions proper.

The method according to the invention can also be implemented in a system including 3 physically independent electronic communication devices: one containing the directory, another being used as a telephone and a third one which is responsible for implementing the method according to the invention.

This embodiment can, for example, be obtained by adding an electronic agenda connected with the telephone and the chip card.

The present invention can also be applied to the enrichment of the electronic directory in the structure and configuration parameters as well as in the data thereof.

1-10. (canceled)

11. A method for automatic enrichment of an electronic directory stored in a first electronic communication device, said first electronic communication device being connected to a second electronic communication device able to set up a phone communication, said first device being able to enrich said electronic directory and implement said method of enrichment, wherein the method includes the steps of:
detection during which a modification of a hardware or software parameter to be watched of said second electronic communication device is automatically detected by said first electronic device;
diagnostics during which the diagnostics of said second device is executed thus making it possible to identify the detected modification;
processing during which predefined decisional rules are applied to said diagnostics, and an enrichment of said electronic directory is planned.

12. A method according to claim 11, wherein the step of diagnostics includes an analysis of the whole or a part of the data contained in a memory of said second device.

13. A method according to claim 11, wherein the step of detection includes a detection of a modification relative to the equipment connected to said second device.

14. A method according to claim 11, wherein said first device is a Sim card.

15. A method according to claim 11, wherein said second device is a mobile telephone.

16. An electronic communication device able to enrich an electronic directory, comprising:
means for detecting at least one modification in a hardware or software parameter to be watched of a second electronic communication device;
means for identifying the modification of said second device which occurred, through a diagnostics of said second device;
means for storing decisional rules;
means for analysing said decisional rules with regard to said diagnostics;
means for planning an enrichment of said electronic directory.

17. An electronic communication device according to claim 16, wherein the device stores the information resulting from the latest diagnostics executed in a non-volatile memory.

18. An electronic communication device according to claim 16, wherein the device stores said electronic directory in a non-volatile memory.

19. An electronic communication device according to claim 16, wherein the device comprises a Sim card.

20. A method according to claim 12, wherein the step of detection includes a detection of a modification relative to the equipment connected to said second device.

21. A method according to claim 12, wherein said first device is a Sim card.

22. A method according to claim 13, wherein said first device is a Sim card.

23. A method according to claim 12, wherein said second device is a mobile telephone.

24. A method according to claim 13, wherein said second device is a mobile telephone.

25. A method according to claim 14, wherein said second device is a mobile telephone.

26. An electronic communication device according to claim 17, wherein the device stores said electronic directory in a non-volatile memory.

27. An electronic communication device according to claim 17, wherein the device comprises a Sim card.

28. An electronic communication device according to claim 18, wherein the device comprises a Sim card.
